(19) United States
(12) Patent Application Publication
(10) Pub. No.: US 2010/0135700 A1
(43) Pub. Date: Jun. 3, 2010

(54) DEVELOPER ,DEVELOPING UNIT,DEVELOPING DEVICE,AND IMAGE FORMING APPARATUS

(75) Inventors: Yoshinori Mutoh, Osaka (JP); Tadashi Iwamatsu, Osaka (JP); Takanori Kamoto, Osaka (JP); Nobuyuki Yoshioka, Osaka (JP); Hiroyuki Hirakawa, Osaka (JP); Takashi Hara, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka-shi, Osaka (JP)

(21) Appl. No.: 12/451,652

(22) PCT Filed: Mar. 26, 2008
(86) PCT No.: PCT/JP2008/055741

§ 371 Date: Nov. 23, 2009

(30) Foreign Application Priority Data
May 29, 2007 (JP) 2007-142620

(51) Int. Cl. G03G 15/08; G03G 9/08; G03G 9/09; G03G 9/097; G03G 9/113; G03G 9/10

(52) U.S. Cl. 399/254; 430/111.41; 430/108.7; 430/108.24; 430/108.3; 430/110.1; 399/252

(57) ABSTRACT

A developer of the present invention includes a toner and a carrier. The toner contains a charge control agent, and the carrier has on its surface a coating layer to which a charge control agent and electrically conductive particles are added. All of constituent elements of one of the charge control agent of the toner and the charge control agent of the carrier are contained in constituent elements of the other one of the charge control agents. With the configuration, the developer of the present invention is capable of stably maintaining a toner charge amount and outputting high-quality images for long periods.

### TECHNICAL FIELD

The present invention relates to: a developer used in an electrophotographic printing method for developing and visualizing an electrostatic latent image formed on an image bearing member; and a developing device and an image forming apparatus each of which uses the developer.

### BACKGROUND ART

Conventionally, in an image outputting apparatus, such as a printer or a copying machine, utilizing an electrophotographic technology, (i) a two component developer containing a toner and a carrier, or (ii) a single component developer containing only a toner has been used as a developer for developing and visualizing an electrostatic latent image formed on an image bearing member. A magnetic brush developing method in which the two component developer out of the developers above is used has been widely used so far, because the magnetic brush developing method is (i) superior to other developing methods in terms of image quality, (ii) capable of colorization, and (iii) comparatively lower in cost.

An image forming apparatus using the conventional magnetic brush developing method includes a developer bearing member including: a hollow cylindrical metal sleeve; and a magnet roller provided inside the metal sleeve. In the magnet roller, a permanent magnet is provided so that a negative pole and a positive pole are alternately provided. This permanent magnet is a magnetic field generating means. The developer bearing member bears, on a surface of the metal sleeve, the two component developer, and only the metal sleeve is rotated while the magnet roller is fixed. This allows the two component developer to be carried to a developing area facing the image bearing member on which the electrostatic latent image is formed. Then, only a toner which is charged is electrostatically adhered to the image bearing member by a developing electric field applied between the developer bearing member and the image bearing member, whereby a visible image is formed.

The toner contained in the two component developer is triboelectrically charged by being mixed with the carrier and stirred in a developing unit including the developer bearing member. It is an important factor to stabilize a toner charge amount for continuing to output high-quality images for long periods. Under the circumstances, the carrier for charging the toner remains in the developing unit for long periods, unlike the toner. Accordingly, there is a concern of deterioration in a charge imparting property of the carrier due to a toner spent, a shift of an external additive, and stress from stirring and mixing. In addition, there is also a concern of contamination inside the image forming apparatus due to toner scattering caused by the deterioration in the charge imparting property. Accordingly, it is required to provide a highly durable carrier which is resistance to deterioration over time and capable of stably maintaining the toner charge amount for long periods. In order to solve the problems, various efforts have been made, for example, for a prescription of a charge control additive which is added to a resin material for coating a core material of the carrier.

For example, Patent Literature 1 discloses a technique in which a charge control agent having a salt structure including a hydrophobic cation and a hydrophilic anion is externally added to a surface of one of a toner and a carrier or surfaces of both of the toner and the carrier.

Patent Literature 2 discloses a technique in which a charge control agent which has a polarity identical to a polarity of a toner is adhered to a surface of a carrier by 0.1×10⁻³% to 3.0×10⁻³% by weight with respect to a carrier weight.

Patent Literature 3 discloses a technique in which each of (i) a magnetic toner containing a charge control agent and (ii) a magnetic carrier is mixed with a specific amount of another charge control agent which has charging property equal to or higher than a charging property of each of the charge control agents.

Patent Literature 4 discloses a developer using a carrier provided with a coating layer, as a carrier coating layer, that contains a charge control agent which has a polarity identical to a polarity of a toner. Patent Literature 4 is directed to a developer for a monochrome image, and employs the toner that has a particle size of 10 μm to 20 μm.

Patent Literature 5 discloses a developer containing a carrier which (i) is partially coated with a synthetic resin charged in a polarity identical to that of a toner or (ii) contains the synthetic resin therein.

### Citation List

Patent Literature 1

Japanese Patent Application Publication, Tokukaihei, No. 2-223956 A (Publication Date: Sep. 6, 1990)

Patent Literature 2

Japanese Patent Application Publication, Tokukaihei, No. 5-303234 A (Publication Date: Nov. 16, 1993)

Patent Literature 3

Japanese Patent Application Publication, Tokukaihei, No. 4-116662 A (Publication Date: Apr. 17, 1992)

Patent Literature 4

Japanese Patent Application Publication, Tokukaisho, No. 62-11864 A (Publication Date: Jan. 20, 1987)

Patent Literature 5

Japanese Examined Patent Application Publication, Tokukouhei, No. 5-49982 A (Publication Date: Jul. 27, 1993)

### SUMMARY OF INVENTION

As described above, it is a crucially important object to improve stability of a toner charge amount obtained by triboelectric charging with a carrier, for maintaining high-quality image formation for long periods. Therefore, it is urgently needed to explore and select a technique for dealing with deterioration in performance of the carrier caused by, for example, peeling of the coating resin due to toner spent on the carrier, a shift of an external additive onto the carrier, and/or mechanical stress.

However, the conventional techniques can hardly provide a sufficient effect. In particular, a sufficient effect cannot be attained by a small particle-sized toner which has been widely used in these years and a toner, such as a color toner, to which large particles are externally added for improving a transfer efficiency.

More specifically, according to disclosure of the technique in Patent Literature 1, a hydrophobic cation is selectively attached to a toner having a hydrophobic surface and a hydrophilic anion is selectively attached to a carrier having a hydrophilic surface. Accordingly, no difference occurs in a charging mechanism depending on whether the charge control agent is provided to the toner or the carrier, and this provides a stable charging property. However, most of the charge control agent is present on the surface of the toner or the carrier because the charge control agent is externally added to the toner or the carrier. Accordingly, the charge control agent comes off from the surface of the toner or the carrier together with chipping and peeling of toner particles or a carrier coating resin over time, due to mechanical stress in a developing unit. As a result, a sufficient charging property of the toner cannot be obtained.

According to disclosure of the technique in Patent Literature 2, deterioration in a toner charge amount can be prevented by adhering a charge control agent, which has a polarity identical to that of the toner, to a surface of the carrier. However, as with Patent Literature 1, the charge control agent is present only on the surface of the carrier. In this case, a ratio at which the charge control agent is present on the surface of the carrier is gradually decreased due to deterioration caused by mechanical stress over time. This may lead to a charging failure of the toner.

According to disclosure of the technique in Patent Literature 3, each of a magnetic toner and a magnetic carrier is mixed with a specific amount of another charge control agent having a chargeability equal to or higher than that of a charge control agent of the toner. This improves the charging property of the toner, and also improves sharpness of an image as well as increasing density and resolution of the image. However, as with Patent Literatures 1 and 2, the technique of Patent Literature 3 still may cause a charging failure of the toner due to deterioration caused by mechanical stress over time.

According to disclosure of the technique in Patent Literature 4, the technique employs a carrier provided with a coating layer containing a charge control agent which has a polarity identical to that of the toner. This makes it possible to prevent a change in charge amount due to continuous copying and to achieve a copy having a high image quality from the beginning. This effect can be found in a case where the toner to be charged is a toner, for a monochrome image, that includes an electrically conductive material such as a carbon black. However, in a case where the toner to be charged is a toner such as a color toner which has a high insulating property, the effect is not provided continuously. A possible reason for this is that, in a case where the charge control agent is simply contained in the carrier coating resin layer, a resistance of the whole carrier cannot be controlled and this makes it difficult for the carrier to give and receive electric charge to and from the color toner which has a high insulating property. Further, in a case of a full color image formation process using the color toner, toners are provided in multi-layers for forming an image. In this case, for improving a transfer efficiency of the toner, external additives tend to be used more than that in a case of a monochrome image formation process using a black toner. Accordingly, the external additives are easily adhered to the surface of the carrier. This prevents an opportunity of contact charging and deteriorates charging performance.

According to disclosure of the technique in Patent Literature 5, the carrier (i) is partially coated with a synthetic resin charged in a polarity identical to that of the toner, or (ii) includes the synthetic resin therein. This makes it possible to obtain stable image density even after continuous printing. However, a resistance value is high because the carrier coating layer is made of the synthetic resin, and in combination with the color toner having a high insulating property, a charging property drastically deteriorates.

The present invention is attained in view of the problems above, and an object of the present invention is to realize a developer, a developing device, and an image forming apparatus each of which is capable of stably maintaining a toner charge amount, especially for a toner having a small particle size, and outputting high-quality images for long periods.

In order to attain the object, a developer of the present invention includes: a toner; and a carrier, wherein: the toner contains a charge control agent; the carrier has, on a surface of the carrier, a coating layer to which a charge control agent and electrically conductive particles are added; and all of constituent elements of one of the charge control agent contained in the toner and the charge control agent of the carrier are contained in constituent elements of the other one of the charge control agents.

According to the configuration, each of the constituent elements of the charge control agent contained in the coating layer of the carrier is identical to one of the constituent elements of the charge control agent contained in the toner. Alternatively, each of the constituent elements of the charge control agent contained in the toner is identical to one of the constituent elements of the charge control agent contained in the coating layer of the carrier. The coating layer of the carrier contains the charge control agent and the electrically conductive particles, whereby a stable amount of charge can be imparted to the toner even in a case where the number of printed sheets is increased. The charge control agent and the electrically conductive particles which are present on a newly exposed surface of the coating layer serve effectively, even in a case where the coating layer is chipped or peeled due to mechanical stress applied on the carrier during a long-term use. This makes it possible to prevent a decrease in the toner charge amount in accordance with deterioration of the carrier due to an increase in the number of sheets printed.

Moreover, in order to attain the object, a developer of the present invention includes: a toner; and a carrier, wherein: the carrier has on its surface a coating layer to which a charge control agent and electrically conductive particles are added; and the charge control agent includes elements identical to constituent elements of the charge control agent contained in the toner.

According to the configuration, a combination of (i) the charge control agent including the elements identical to the constituent elements of the charge control agent contained in the toner and (ii) electrically conductive particles is added to the coating layer of the carrier, whereby a stable amount of charge can be imparted to the toner even in a case where the number of sheets printed is increased. The charge control agent and the electrically conductive particles which are present on a newly exposed surface of the coating layer serve effectively, even in a case where the coating layer is chipped or peeled due to mechanical stress applied on the carrier during a long-term use. This makes it possible to prevent a decrease in the toner charge amount in accordance with deterioration of the carrier due to an increase in the number of sheets printed.

For a fuller understanding of the nature and advantages of the invention, reference should be made to the ensuing detailed description taken in conjunction with the accompanying drawings.

### BRIEF DESCRIPTION OF DRAWINGS

FIG. 1 is a diagram schematically illustrating a toner and a carrier included in a developer, according to an embodiment of the present invention.

FIG. 2 is a schematic view illustrating a developing device, according to the embodiment of the present invention.

FIG. 3 is a graph illustrating transitions of toner charge amounts in an aging process using developers of Example and Comparative Examples.

FIG. 4 is a graph illustrating amounts of changes in toner charge amounts in the aging process using the developers in Example and Comparative Examples.

FIG. 5 is a graph illustrating a comparison of transitions of toner charge amounts in an aging process, between (i) a case where the developer of Example contains electrically conductive particles in a resin contained in a coating layer and (ii) a case where the developer of Example does not contain the electrically conductive particles in the resin.

FIG. 6 is a graph illustrating a comparison of transitions of toner charge amounts in an aging process, between (i) a case where the developer of Comparative Example contains electrically conductive particles in a resin contained in a coating layer and (ii) a case where the developer of Comparative Example does not contain the electrically conductive particles in the resin.

FIG. 7 is a graph illustrating transitions of toner charge amounts in an aging process in a case where amounts of respective charge control agents added to resins included in coating layers are varied in developers of Example and Comparative Examples.

FIG. 8 is a graph illustrating transitions of changes in toner charge amounts in an aging process in a case where amounts of respective charge control agents added to resins included in coating layers are varied in developers of Example and Comparative Examples.

### DESCRIPTION OF EMBODIMENTS

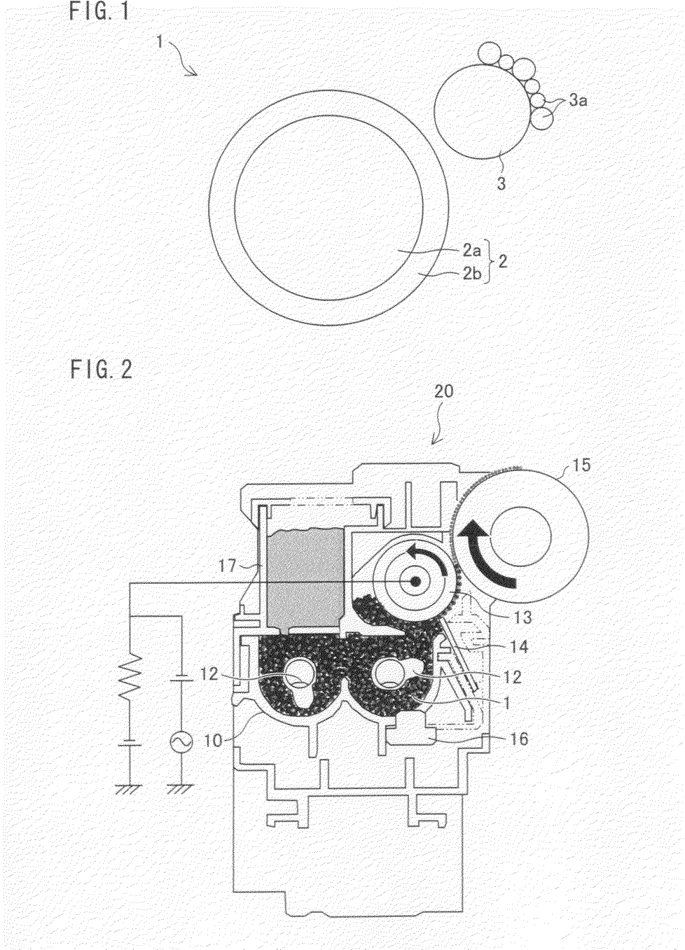

One embodiment of the present invention is described below with reference to FIGS. 1 and 2.

A developer 1 is a two component developer containing a toner 3 and a carrier 2. The following describes the toner, the carrier, and the developer in this order.

(Toner)

The toner 3 essentially includes a binder resin and a colorant as toner materials, and other than these, the toner 3 includes a charge control agent and a release agent. Moreover, the toner 3 includes two or more of external additives which have particle sizes different from each other.

The binder resin is not limited in particular, but a known binder resin for a black toner or a color toner can be used. For example, the binder resin may be: a polyester resin; a styrene resin such as polystyrene or styrene-acrylic acid ester copolymer resin; an acrylic resin such as polymethylmethacrylate; a polyblefin resin such as polyethylene; polyurethane; or an epoxy resin. Moreover, it is possible to use a resin obtained by a polymerization reaction in which a raw monomer mixture is mixed with a release agent. The binder resins may be used alone individually or in combination of two or more.

In a case where the polyester resin is used as the binder resin, examples of an aromatic alcohol component for obtaining the polyester resin may be bisphenol-A, polyoxyethylene-(2.2)-2,2-bis(4-hydroxyphenyl)propane, polyoxyethylene-(2.0)-2,2-bis(4-hydroxyphenyl)propane, polyoxypropylene-(2.0)-2,2-bis(4-hydroxyphenyl)propane, polyoxypropylene-(2.2)-polyoxyethylene-(2.0)-2,2-bis(4-hydroxyphenyl)propane, polyoxypropylene-(6)-2,2-bis(4-hydroxyphenyl)propane, polyoxypropylene-(2.2)-2,2-bis(4-hydroxyphenyl)propane, polyoxypropylene-(2.4)-2,2-bis(4-hydroxyphenyl)propane, polyoxypropylene-(3.3)-2,2-bis(4-hydroxyphenyl)propane, and derivatives of these.

Moreover, a polybasic acid component of the polyester resin may be: dibasic acids such as succinic acid, adipic acid, sebacic acid, azelaic acid, dodecenylsuccinic acid, n-dodecylsuccinic acid, malonic acid, maleic acid, fumaric acid, citraconic acid, itaconic acid, glutaconic acid, cyclohexanedicarboxylic acid, orthophthalic acid, isophthalic acid, or terephthalic acid; tribasic or higher acids such as trimellitic acid, trimethine acid, or pyromellitic acid, or anhydrides of these; or lower alkyl esters. In view of heat resistance and cohesiveness, the terephthalic acid or a lower alkyl ester thereof is preferable.

It is preferable that the polyester resin constituting the toner has acid number of 5 mgKOH/g to 30 mgKOH/g. In a case where the acid number is less than 5 mgKOH/g, a charging property of the resin is deteriorated and it becomes difficult for the charge control agent to disperse in the polyester resin. This affects adversely on stability in charge amount at initial rise and during repetitive development in continuous use. Therefore, the range from 5 mgKOH/g to 30 mgKOH/g is preferable.

As the colorant, various kinds of colorants may be used in accordance with desired colors. For example, the colorant may be a colorant for a yellow toner, a colorant for a magenta toner, a colorant for a cyan toner, or a colorant for a black toner.

Examples of the colorant for a yellow toner may be colorants classified by a color index, that is, an azo pigment such as C.I. pigment yellow 1, C.I. pigment yellow 5, C.I. pigment yellow 12, C.I. pigment yellow 15, or C.I. pigment yellow 17; an inorganic pigment such as yellow iron oxide or loess; a nitro dye such as C.I. acid yellow 1; and an oil-soluble dye such as C.I. solvent yellow 2, C.I. solvent yellow 6, C.I. solvent yellow 14, C.I. solvent yellow 15, C.I. solvent yellow 19, or C.I. solvent yellow 21.

Examples of the colorant for a magenta toner may be: C.I. pigment red 49, C.I. pigment red 57, C.I. pigment red 81, C.I. pigment red 122, C.I. solvent red 19, C.I. solvent red 49, C.I. solvent red 52, C.I. basic red 10, and C.I. disperse red 15, which are classified by the color index.

Examples of the colorant for a cyan toner may be: C.I. pigment blue 15, C.I. pigment blue 16, C.I. solvent blue 55, C.I. solvent blue 70, C.I. direct blue 25, and C.I. direct blue 86, which are classified by the color index.

Examples of the colorant for a black toner may be: carbon blacks such as channel black, roller black, disk black, gas furnace black, oil furnace black, thermal black, or acetylene black. A carbon black may be selected from these carbon blacks as appropriate in accordance with a desired design characteristic of the toner.

The colorant may be a crimson pigment, a green pigment, etc., other than above cited pigments. The colorants may be used alone individually or in combination of two or more. Moreover, the colorants may be used (i) in combination of two or more similar colors or (ii) one or in combination of two or more different colors.

The colorant may be used in a masterbatch form. The masterbatch of the colorant can be produced in the same way as a general masterbatch. For example, the masterbatch can be produced, by kneading a molten synthetic resin with the colorant so that the colorant can be uniformly dispersed in the synthetic resin. Then, the resultant mixture is granulated so that the masterbatch is produced. The synthetic resin may be either the same type as the binder resin of the toner, or a synthetic resin which has a good compatibility with the binder resin of the toner. In this case, a ratio of the synthetic resin and the colorant is not limited in particular. However, it is preferable that the ratio of the colorant is 30 parts to 100 parts by weight with respect to 100 parts by weight of the synthetic resin. Moreover, the masterbatch is granulated into particles having a particle size of approximately 2 mm to 3 mm.

The colorant is not limited in amount in particular. However, it is preferable that the amount of the colorant is 5 parts to 20 parts by weight with respect to 100 parts by weight of the binder resin. This amount is not an amount of the masterbatch, but an amount of the colorant itself contained in the masterbatch. The use of the colorant within the above range allows formation of an image having a high image density and an excellent image quality, without impairing properties of the toner.

The charge control agent is added for controlling a triboelectric charging property of the toner 3. The charge control agent may be a charge control agent which is either for positive electric charge or for negative electric charge and which is generally used in this field. Examples of the charge control agent for positive electric charge may be a nigrosine dye, a basic dye, quaternary ammonium salt, quaternary phosphonium salt, aminopyrine, a pyrimidine compound, a polynuclear polyamino compound, aminosilane, a nigrosine dye or a derivative thereof, a triphenylmethane derivative, guanidine salt, and amidine salt. Examples of the charge control agent for negative electric charge may be an oil soluble dye such as oil black or spirone black, a metal-containing azo compound, an azo complex dye, metal naphthenate, a metal complex or a metal salt of salicylic acid, or a metal complex or a metal salt of a derivative of salicylic acid (the metal is chromium, zinc, zirconium, etc.), a boron compound, fatty acid soap, long-chain alkylcarboxylic acid salt, and resin acid soap. In particular, the boron compound is preferable because the boron compound does not contain any heavy metal. These charge control agents for positive electric charge and negative electric charge may be used as appropriate in accordance with each application. The charge control agents may be used alone individually or in combination of two or more as appropriate. An amount of the charge control agent to be used is not limited but the amount can be selected from a wide range as appropriate. However, it is preferable that the amount of the charge control agent is 0.5 parts to 3 parts by weight with respect to 100 parts by weight of the binder resin.

The release agent may be a release agent which is generally used in this field. Examples of the release agent may be: petroleum wax such as paraffin wax or a derivative thereof, and microcrystalline wax or a derivative thereof; hydrocarbon synthetic wax such as Fischer-Tropsch wax or a derivative thereof, polyolefin wax or a derivative thereof, low-molecular-weight polypropylene wax or a derivative thereof, or polyolefin polymer wax (such as low-molecular-weight polyethylene wax) or a derivative thereof; plant wax such as carnauba wax or a derivative thereof, rice wax or a derivative thereof, candelilla wax or a derivative thereof, or Japan wax; animal wax such as bees wax or spermaceti; oil and fat synthetic wax such as fatty acid amide or phenol fatty acid ester; long-chain carboxylic acid or a derivative thereof; long-chain alcohol or a derivative thereof; silicone polymer; and higher fatty acid. Note that the derivative encompasses, for example: an oxide; a block copolymer of a vinyl monomer and wax; and wax graft denatured with a vinyl monomer. An amount of the release agent to be used is not limited particularly but the amount can be selected from a wide range as appropriate. However, it is preferable that the amount of the release agent is 0.2 parts to 20 parts by weight with respect to 100 parts by weight of the binder resin.

An external additive 3a of the toner 3 may be an external additive which is generally used in this field. Examples of the external additive may be silicon oxide, titanium oxide, silicon carbide, aluminum oxide, and barium titanate. In the present embodiment, two or more external additives which have particle sizes different from each other are used together, and at least one of them has a primary particle size of 0.1 μm or more. In a case where at least one of the external additives 3a has a primary particle size of 0.1 μm or more, particularly in a color toner, a transfer characteristic is improved. In addition, the toner 3 can be charged stably for long periods, without causing deterioration in charge due to adhesion of the external additive 3a to a surface of the carrier 2. An amount of the external additive to be used is not limited in particular. However, it is preferable that the amount of the external additive is 0.1 parts to 3.0 parts by weight with respect to 100 parts by weight of the toner 3.

Those raw materials of the toner 3, except for the external additive, are mixed by a mixer such as a Henschel Mixer, a super mixer, a Mechano Mill, or a Q-type mixer. The resultant mixture of the raw materials is fused and kneaded at a temperature of 70° C. to 180° C. by a kneading machine such as a biaxial kneader, a uniaxial kneader, or a continuous double-roll type kneader, and then solidified by cooling. The mixture of the raw materials of the toner 3 after the solidification is ground roughly by a cutter mill, a feather mill, or the like. The ground mixture is further finely pulverized by a jet mill, a fluidized-bed jet mill, or the like. In these mills, airflows including the toner particles are caused to collide with each other from a plurality of directions, whereby the toner particles collide with each other. As a result, the toner particles are pulverized. This makes it possible to produce a nonmagnetic toner 3 having a specific particle size distribution. The particle size of the toner 3 is not limited in particular, but is preferable to have an average particle size in a rage of 5 μm to 7 μm. Further, it is possible to adjust the particle size by a classification if necessary. The external additive 3a is added to the toner 3 produced as above, with use of a known method. Note that the production method of the toner 3 is not limited to the above described method.

(Carrier)

The carrier 2 of the present embodiment includes a carrier core 2a and a coating layer. 2b. As shown in FIG. 1, the coating layer 2b is formed on a surface of the carrier core 2a, in view of imparting sufficient electric charge to the toner 3. The coating layer 2b is made of a coating resin composition containing a charge control agent and electrically conductive particles.

The carrier core 2a may be a carrier core which is generally used in this field. The carrier core may be made of, for example: magnetic metal such as iron, copper, nickel, or cobalt; or magnetic metal oxide such as ferrite or magnetite. In a case where the carrier core 2a is made of the magnetic material, it is possible to obtain a carrier which is suitable for a developer used for a magnetic brush developing. It is preferable that the carrier core 2a has an average particle size of 25 μm to 100 μm.

The coating resin composition constituting the coating layer 2b on the surface of the carrier core 2a is a composition in which a resin contains (i) a charge control agent having the same composition as a charge control agent included in the toner and (ii) electrically conductive particles.

The resin of the coating resin composition is not limited in particular but may be a known resin. However, in view of compatibility between (i) releasability from the toner 3 and (ii) adhesiveness to the carrier core 2a, it is preferable to use a silicone resin for obtaining a desirable result.

The silicone resin is not limited in particular, but may be a silicone resin generally used in this field. However, it is preferable to use a crosslinkable silicone resin as the silicone resin. As shown in the following chemical formulae, the crosslinkable silicone resin is a known silicone resin which is cured by cross-linking of (i) hydroxyl groups each bonding with a Si atom or (ii) a hydroxyl group and an —OX group each bonding with a Si atom, through a thermal dehydration reaction, a room temperature curing reaction, or the like reaction.

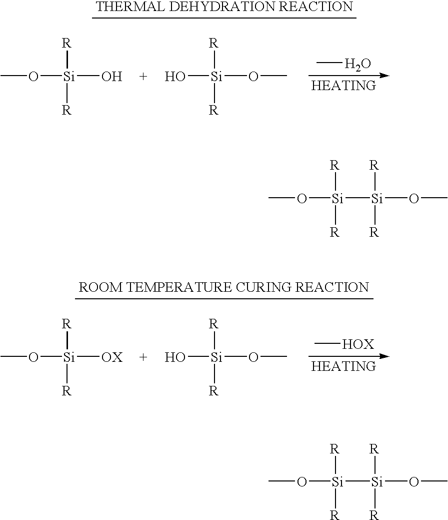

(In the formulae, the plurality of Rs represent identical or different univalent organic groups. The —OX group represents an acetoxy group, an aminoxy group, an alkoxy group, an oxime group, or the like.)

The crosslinkable silicone resin may be either a heat curing type silicone resin or a room temperature curing type silicone resin. The heat curing type silicone resin needs to be heated to approximately 200° C. to 250° C. so that the heat curing type silicone resin is cross-linked. The room temperature curing type silicone resin can be cured without heating. However, for shortening a time for curing, it is preferable to heat up the room temperature curing type silicone resin at a temperature of 150° C. to 280° C.

Among crosslinkable silicone resins, a preferable silicone resin has a methyl group as the univalent organic group represented by R. The crosslinkable silicone resin in which R is a methyl group has a dense cross-linked structure. Accordingly, formation of the coating layer 2b by using the crosslinkable silicone resin can provide a carrier 2 excellent in water repellency, moisture resistance, and the like. However, in a case where the cross-linked structure is overly dense, the coating layer 2b tends to become fragile. Therefore, it is important to select an appropriate molecular weight of the crosslinkable silicone resin.

Moreover, it is preferable that a ratio by weight of silicon to carbon (Si/C) in the crosslinkable silicone resin is 0.3 to 2.2. In a case where the Si/C is less than 0.3, a hardness of the coating layer 2b may be decreased, and this may shorten a life of the carrier 2. On the other hand, in a case where the Si/C is more than 2.2, a charge imparting property of the carrier 2 with respect to the toner 3 is easily affected by a temperature change, whereby the coating layer 2b may become fragile.

In a case where the crosslinkable silicone resin is used as the coating resin composition, the crosslinkable silicone resin may be a commercially available crosslinkable silicone resin. Examples of such a crosslinkable silicone resin may be SR2400, SR2410, SR2411, SR2510, SR2405, 840RESIN and 804RESIN (product names, manufactured by Dow Corning Toray Co., Ltd.), and KR271, KR272, KR274, KR216, KR280, KR282, KR261, KR260, KR255, KR266, KR251, KR155, KR152, KR214, KR220, X-4040-171, KR201, KR5202, and KR3093 (product names, manufactured by Shin-Etsu Chemical Co., Ltd.). The crosslinkable silicone resins may be used alone individually, or in combination of two or more.

Moreover, a denatured silicone resin such as an acrylic or epoxy resin may be used in view of improvement in adhesiveness to the carrier core 2a.

Regarding the charge control agent contained in the coating layer 2b of the carrier 2, it is preferable that all constituent elements of one of the charge control agents of the toner 3 and the charge control agent of the carrier 2 are included in constituent elements of the other charge control agent. Furthermore, it is preferable that the charge control agent contained in the coating layer 2b of the carrier 2 is made of elements identical to constituent elements of the charge control agent contained in the toner 3. In particular, it is preferable that the charge control agent contained in the coating layer 2b of the carrier 2 has a composition identical to that of the charge control agent contained in the toner 3. The identical composition means that chemical formulae are the same.

Accordingly, the charge control agent for either positive electric charge or negative electric charge may be used for a charge control agent of the carrier 2, in accordance with the charge control agent contained in the toner 3. Examples of the charge control agent for positive electric charge may be a nigrosine dye, a basic dye, quaternary ammonium salt, quaternary phosphonium salt, aminopyrine, a pyrimidine compound, a polynuclear polyamino compound, aminosilane, a nigrosine dye or a derivative thereof, a triphenylmethane derivative, guanidine salt, and amidine salt. Examples of the charge control agent for negative electric charge may be an oil soluble dye such as oil black or spirone black, a metal-containing azo compound, an azo complex dye, metal naphthenate, a metal complex or a metal salt of salicylic acid, or a metal complex or a metal salt of a derivative thereof (the metal is chromium, zinc, zirconium, etc.), a boron compound, fatty acid soap, long-chain alkylcarboxylic acid salt, and resin acid soap. In particular, the boron compound is preferable because the boron compound does not contain any heavy metal.

In a case where the charge control agent contained in the toner 3 is salt, it is preferable that the charge control agent contained in the coating layer 2b of the carrier 2 is salt of the same kind. For example, in a case where the charge control agent contained in the toner 3 is Boro bis (1.1-diphenyl-1-oxo-acetyl) potassium Salt, salt of the same kind may be potassium tetraphenylborate, potassium tetrakis[3,5-bis(trifluoromethyl)phenyl]borate, or potassium tetrakis(4-chlorophenyl)borate.

Note that the charge control agents may be used alone individually or in combination of two or more as appropriate. An amount of the charge control agent to be used is not limited in particular, but the amount can be selected from a wide range as appropriate. However, it is preferable that the charge control agent is 5 parts to 10 parts by weight with respect to 100 parts by weight of a resin contained in the coating resin composition. More preferably, the amount of the charge control agent is 5 parts to 7 parts by weight.

The electrically conductive particles may be, for example: an electrically conductive carbon black; or an oxide such as electrically conductive titanium oxide or tin oxide. The carbon black, etc. is suitable for providing electrical conductivity by adding a small amount of the electrically conductive particles. However, in a case where a color toner is used, there is a concern that carbon may come off from the coating layer 2b of the carrier 2. In such a case, for example, electrically conductive titanium oxide doped with antimony is used.

Further, the carrier 2 may contain a silane coupling agent for adjusting a charge amount of the toner 3. More specifically, it is preferable to use a silane coupling agent which has an electron-donating functional group. The silane coupling agent may be, for example, an amino-group-containing silane coupling agent. The amino-group-containing silane coupling agent may be a known amino-group-containing silane coupling agent. The amino-group-containing silane coupling agent may be represented by the following Formula (1), for example.

(Y)nSi(R)m (1)

(In the formula, the number m of Rs represent identical or different alkyl groups, alkoxy groups or chlorine atoms. The number n of Y represent hydrocarbon groups containing identical or different amino groups. Each of m and n represents an integer in a range of 1 to 3. Note however that m+n=4.)

In Formula (1), the alkyl group represented by R may be, for example, a straight-chain or branched-chain alkyl group having a carbon number of 1 to 4 such as a methyl group, an ethyl group, a propyl group, an isopropyl group, a butyl group, an isobutyl group, or a tert-butyl group. In particular, the methyl group, the ethyl group, or the like may be preferably used. The alkoxy group may be, for example, a straight-chain or branched-chain alkoxy group having a carbon number of 1 to 4 such as a methoxy group, an ethoxy group, a propoxy group, an isopropoxy group, a butoxy group, an isobutoxy group, or a tert-butoxy group. In particular, the methoxy group, the ethoxy group, or the like may be preferably used. The amino-group containing hydrocarbon group represented by Y may be, for example, —(CH₂)a-X (where X represents an amino group, an aminocarbonyl amino group, an aminoalkyl amino group, a phenylamino group, or a dialkylamino group, and a represents an integer of 1 to 4), or -Ph-X (where X is the same as the above and -Ph- represents a phenylene group).

Specific examples of the amino-group-containing silane coupling agent may be:

H₂N(H₂C)₃Si(OCH₃)₃,

H₂N(H₂C)₃Si(OC₂H₅)₃,

H₂N(H₂C)₃Si(CH₃)(OCH₃)₂,

H₂N(H₂C)₂HN(H₂C)₃Si(CH₃)(OCH₃)₂,

H₂NOCHN(H₂C)₃Si(OC₂H₅)₃,

H₂N(H₂C)₂HN(H₂C)₃Si(OCH₃)₃,

H₂N-Ph-Si(OCH₃)₃ (where -Ph- represents a p-phenylene group),

Ph-HN(H₂C)₃Si(OCH₃)₃ (where Ph- represents a phenyl group), or

(H₉C₄)₂N(H₂C)₃Si(OCH₃)₃.

The amino-group-containing silane coupling agent may be used alone individually or in combination of two or more. An amount of the amino-group-containing silane coupling agent is selected as appropriate from a range in which (i) electric charge is sufficiently provided to the toner 3 and (ii) a mechanical strength of the coating layer 2b is not significantly decreased. It is preferable that the amount of the amino-group-containing silane coupling agent is 10 parts by weight or lower with respect to 100 parts by weight of the resin contained in the coating resin composition. More preferably, the amount of the amino-group-containing silane coupling agent is 0.01 part to 10 parts by weight.

The coating resin composition may contain, in addition to the silicone resin, another resin within a range in which a desirable characteristic of the resin coating layer formed by using the silicone resin (particularly, the crosslinkable silicone resin) is not impaired. The another resin may be, for example, an epoxy resin, a urethane resin, a phenol resin, an acrylic resin, a styrene resin, polyamide, polyester, an acetal resin, polycarbonate, a vinyl chloride resin, a vinyl acetate resin, a cellulosic resin, polyolefin, a copolymer resin of these, or a compounded resin of these.

The coating resin composition may contain bifunctional silicone oil for further improving, for example, moisture resistance and releasability of the resin coating layer made of the silicone resin (particularly, the crosslinkable silicone resin).

The coating resin composition can be produced by mixing a predetermined amount of a silicone resin and an amino-group-containing silane coupling agent, and, as appropriate, a proper amount of a resin other than the silicone resin and an additive such as bifunctional silicone oil. One form of the coating resin composition may be, for example, a solution form in which the components above are dissolved in an organic solvent. The organic solvent is not limited in particular as long as the organic solvent is capable of dissolving the silicone resin. Examples of the organic solvent may be: aromatic hydrocarbons such as toluene or xylene; ketones such as acetone or methyl ethyl ketone; ethers such as tetrahydrofuran or dioxane; higher alcohols; and a mixed solvent of two or more of these organic solvents. Use of the coating resin composition in the solution form (hereinafter, referred to as “coating resin solution”) allows the coating layer 2b to be easily formed on the surface of the carrier core 2a. The carrier 2 can be produced, for example, through a procedure in which: the coating resin solution is applied to the surface of the carrier core 2a, thereby forming a solution-applied layer; the solution-applied layer is heated so that the organic solvent is volatilized and removed; and the solution-applied layer is cured by heat or simply cured during drying or after drying so that the coating layer 2b is formed.

A method of applying the coating resin solution to the surface of the carrier core 2a may be, for example: a dipping method in which the carrier core 2a is dipped in the coating resin solution; a spraying method in which the coating resin solution is sprayed on the carrier core 2a; or a fluidized-bed method in which the coating resin solution is sprayed on the carrier core 2a which is suspended by a fluidized airflow. Among these methods, the dipping method is preferable because a film can be formed easily.

In the drying of the solution-applied layer, a dry accelerator may be used. The dry accelerator may be a known dry accelerator. Examples of the dry accelerator may be: metal soap such as lead salt, iron salt, cobalt salt, manganese salt, or zinc salt, containing such as naphthyl acid or octylic acid; and organic amines such as ethanolamine. The dry accelerators may be used alone individually or in combination of two or more.

The solution-applied layer is cured by heating at a temperature selected in accordance with a kind of the silicone resin. For example, it is preferable that the heating is carried out at a temperature in a range of approximately 150° C. to 280° C. In a case where the silicone resin is a room temperature curing silicone resin, heating is not necessary.

However, for the purpose of (i) improving a mechanical strength of the resin coating layer to be formed and (ii) shortening a time for curing, the silicone resin may be heated to a temperature of approximately 150° C. to 280° C.

Note that a total solid concentration of the coating resin solution is not limited in particular, but may be adjusted so that a film thickness of the coating layer 2b after curing becomes 5 μm or less in a normal state and preferably approximately 0.1 μm to 3 μm, in view of workability of application to the carrier core 2a.

It is preferable that the obtained carrier 2 has an average particle size of 45 μm or less. Moreover, it is preferable that the carrier 2 has a high electric resistance and a spherical shape. However, even though the carrier 2 has electric conductivity or a nonspherical shape, the advantageous effects of the present invention will not be impaired.

(Developer)

The developer 1 is produced by mixing the toner 3 and the carrier 2. A mixture ratio of the toner 3 and the carrier 2 is not limited in particular. However, in view of use in a high-speed image forming apparatus (by which images in A4 size can be formed at a speed of 40 sheets/min or more), it is preferable that a ratio of a total projected area of the toner (a sum of projected areas of all toner particles) to a total surface area of the carrier (a sum of surface areas of all carrier particles) (i.e., a total projected area of the toner/a total surface area of the carrier×100) should be 30% to 70% in a case where a volume average particle size of the carrier divided by a volume average particle size of the toner is 5 or more. At the ratio, the charging property of the toner 3 can be stably maintained in a sufficiently good condition. Accordingly, the developer 1 can be used as a suitable developer capable of stably forming high quality images for long periods in the high-speed image forming apparatus. For example, in a case where: (i) the volume average particle size of the toner 3 is 6.5 μm; (ii) the volume average particle size of the carrier 2 is 90 μm; and (iii) the ratio of the total projected area of the toner 3 to the total surface area of the carrier 2 is 30% to 70%, the developer 1 includes approximately 2.2 parts to 5.3 parts by weight of the toner with respect to 100 parts by weight of the carrier. When such a developer 1 is used in high-speed development, both a consumption of a toner and a supply of a toner that is supplied to a developer tank of the developing device in accordance with the consumption of the toner become maximum. However, a balance between supply and demand is not impaired. Further, in a case where the amount of the carrier 2 in the developer 1 becomes more than 2.2 parts to 5.3 parts by weight, the charge amount tends to become too small to attain a desired developing characteristic. Besides that, the consumption of the toner becomes larger than the supply of the toner. This makes it difficult to sufficiently charge the toner 3. As a result, the image quality is deteriorated. On the other hand, in a case where the amount of the carrier 2 is less than the range, the charge amount tends to become large. This makes it difficult to release the carrier 2 from the toner 3 due to an electric field. This results in deterioration of the image quality.

Note that the total projected area of the toner is calculated as follows in the present embodiment. On assumption that a specific gravity of the toner is 0.1, the total projected area of the toner is calculated based on a volume average particle size obtained by a Coulter Counter (product name: Coulter Counter Multisizer II, manufactured by Beckman Coulter, Inc.). That is, the number of the toner particles corresponding to a weight of the toner to be mixed is calculated, and the number of the toner particles x an area of the toner (calculated by assuming as a circle) is assumed as the total projected area of the toner. Similarly, the total surface area of the carrier is calculated from a weight of the carrier to be mixed, based on a particle size obtained by a Microtrac (product name: Microtrac MT 3000, manufactured by Nikkiso Co., Ltd.). In this case, a specific gravity of the carrier is assumed to be 4.7. The mixture ratio is calculated by the total projected area of the toner/the total surface area of the carrier×100.

(Developing Device and Image Forming Apparatus)

A developing device 20 of the present embodiment develops an image with use of the developer 1 of the present embodiment. As shown in FIG.2, the development device 20 includes: a developing unit 10 for storing the developer 1; and a developer bearing member (developer carrying bearing member) 13 for carrying the developer 1 to an image bearing member 15.

The developer (two component developer) 1, which includes the carrier 2 and the toner 3 in the present embodiment, is provided in the developing unit 10 in advance, and the developer 1 is stirred and charged by a stirring screw 12. Then, the developer 1 is carried to the developer bearing member 13 in which a magnetic field generating means is provided, so that the developer 1 is carried onto a surface of the developer bearing member 13. The developer 1 held on the surface of the developer bearing member 13 is (i) controlled to have a predetermined layer thickness by a developer controlling member 14, and then (ii) carried to a developing area formed in an area where the developer bearing member 13 and the image bearing member 15 come close to each other. Then, an electrostatic charge image on the image bearing member 15 is made visible by a reversal development, under an oscillating electric field formed by applying an alternating-current bias voltage to the developer bearing member 13. The consumption of the toner in the visible image formation is detected by a toner concentration sensor 16. The amount of the toner consumed is supplied from a toner hopper 17 until the toner concentration sensor 16 detects that a predetermined toner concentration is reached. This allows the toner concentration to be kept substantially constant in the developer 1 inside the developing unit 10.

The image forming apparatus of the present embodiment includes the developing device 20. Other than this configuration, the image forming apparatus of the present embodiment is the same as a known electrophotographic image forming apparatus. For example, the image forming apparatus includes: an image bearing member having, on a surface of the image bearing member, a photosensitive layer on which an electrostatic charge image can be formed; a charging means for charging the surface of the image bearing member to a predetermined electric potential; an exposing means for forming the electrostatic charge image (electrostatic latent image) on the surface of the image bearing member by irradiation of signal light in accordance with image information onto the image bearing member whose surface is being charged; a transfer means for transferring, to a recording medium, a toner image transferred to an intermediate transfer member, the toner image being developed on the surface of the image bearing member by supplying the toner 3 from the developing unit 20; a fixing means for fixing the toner image on a surface of the recording medium to the recording medium; a cleaning means for removing toner, paper powder, and the like remaining on the surface of the image bearing member after transfer of the toner image onto the recording medium; and another cleaning means for removing excess toner, or the like which is adhered to the intermediate transfer member.

When the electrostatic charge image is developed, the electrostatic charge image on the image bearing member 15 is developed, for each color of the toner, by a reversal development. Then, a plurality of toner images having colors different from each other are superimposed on the intermediate transfer member, thereby forming a multicolor toner image. The present embodiment employs an intermediate transfer method in which an intermediate transfer member is used. However, it is possible that the toner image is transferred to the recording medium directly from the image bearing member.

The image forming apparatus of the present embodiment is capable of (i) stably maintaining a toner charge amount, and (ii) outputting high-quality images for long periods.

### Examples

The following describes an example of the present invention and comparative examples. The present invention is not limited to the example, within the scope of the invention. In the example and the comparative examples, measurements were carried out with use of developers each of which contained a toner and a carrier.

(Production of Developer)

The following describes a developer (a two component developer) obtained by mixing a toner and a carrier which were used in the present example and the comparative examples.

The toner was produced as follows. Polyester (main resin), a pigment, a release agent, and a charge control agent (manufacturer: Japan Carlit Co., Ltd., product name: LR-147) were fused, kneaded, grinded, and classified. Through these steps, a magenta toner (nonmagnetic magenta toner) was produced. This magenta toner was a negatively charged toner (i) which had a volume average particle size of φ6.7 μm and (ii) to which two kinds of silica were externally added. The two kinds of silica had been hydrophobized and had volume average particle sizes of 100 nm and 12 nm, respectively.

The charge control agent LR-147 used here has a substance name “Boro bis (1.1-diphenyl-1-oxo-acetyl) potassium Salt”, and is represented by a chemical formula C₂₈H₂₀BKO₆.

On the other hand, the carrier was produced as follows. As a carrier core (core material), Mn—Mg—Sr ferrite (manufacturer: Powdertech Co., Ltd., saturated magnetization: 65 emu/g, average particle size: φ35 μm) was used, and a surface of the carrier core was coated with a silicone resin (manufacturer: Dow Corning Toray Co., Ltd., product name: SR2411) in a thickness of 0.5 μm by a dipping method. Into the silicone resin, electrically conductive particles (electrically conductive agent) (manufacturer: Fuji Shikiso Co., Ltd, product name: 9-19-1), a charge control agent, a coupling agent (manufacturer: GE Toshiba Silicones

Co., Ltd., product name: TSL8331), and a curing catalyst (manufacturer: Dow Corning Toray Co., Ltd., product name: SRX67) were added and dispersed. Then, the carrier core coated with the silicone resin was cured at a temperature of 200° C. for one hour, and sieved through a sieve whose size of mesh was 150 μm, whereby the carrier (the magnetic carrier) was produced.

Note that the carrier had a particle density of 4.7 g/cm³, and the toner had a particle density of 1.0 g/cm³. The coating method is not limited to the dipping method, but another method such as a spraying method or a fluidized-bed method can be used.

The charge control agents added to the carrier were the following (1) to (4).
(1) P-51 having a positive charging property which is the reverse of a charging property of the toner (P-51 is manufactured by Orient Chemical Industries Co., Ltd.; hereinafter, a carrier to which P-51 is added is referred to as Type-A).
(2) E-81 having a negative charging property which is identical to a charging property of the toner (E-81 is manufactured by Orient Chemical Industries Co., Ltd.; hereinafter, a carrier to which E-81 is added is referred to as Type-B).
(3) E-84 having a negative charging property which is identical to a charging property of the toner (E-84 is manufactured by Orient Chemical Industries Co., Ltd.; hereinafter, a carrier to which E-81 is added is referred to as Type-C).
(4) LR-147 which has a composition identical to that of the charge control agent added to the toner (i.e., LR-147 is identical to the charge control agent added to the toner) (hereinafter, a carrier to which LR-147 is added is referred to as LR-147).
   The charge control agent P-51 has a substance name “benzyltrimethylammonium 4-hydroxynaphthalene-1-sulfonate”, and is represented by a chemical formula C₂₉H₄₁NSO₄. That is, the charge control agent P-51 includes constituent elements different from those of the charge control agent LR-147. Furthermore, not all the constituent elements of one of these charge control agents are contained in the constituent elements of the other charge control agent. Moreover, E-81 has a substance name “alkyl (c=8 to 10) salicylate (Cr)”, and is represented by a chemical formula C₃₀H₄₀CrO₆. As with P-51, the charge control agent E-81 includes constituent elements different from those of the charge control agent LR-147. Furthermore, E-84 has a substance name “zinc 3,5-di-tert-butylsalicylate”, and is represented by a chemical formula C₃₀H₄₀ZnO₆. Similarly, the charge control agent E-84 includes constituent elements different from those of the charge control agent LR-147.

Note that the four charge control agents (1) to (4) were all added by the same amount, that is, 10 parts by weight with respect to 100 parts by weight of the resin contained in the coating layer (carrier coating layer). Moreover, each of the carriers were arranged to include: 2 parts by weight of the silicone resin with respect to 100 parts by weight of the carrier core (core material). Further, 5 parts by weight of the electrical conductive agent, 3 parts by weight of the coupling agent, and 1 part by weight of the curing catalyst were added to each of the carriers with respect to 100 parts by weight of the coating resin.

In each of the two component developers obtained by mixing the toner and each of the carriers, a mixture ratio by weight of the toner (hereinafter, referred to as a toner concentration) with respect to the gross weight of each of the developers was set to 9 wt %. Each of the developers was produced by (i) putting the toner and each of the carriers in a resin cylindrical container and then (ii) mixing and stirring the toner and each of the carriers on a double-axis driving plastic-container/glass-bottle rotating platform at a speed of 200 rpm for one hour.

(Aging Test)

The following describes a measuring instrument and a measuring condition for an aging test of the four types (one type of toner×four types of carriers) of two component developers produced under the above described condition.

The aging test was carried out in continuous image printing at a coverage rate of 5% by using a digital multifunction printer, with use of the four types of the two component developers produced under the condition described above. The digital multifunction printer used in the test was a digital full color multifunction printer MX-6200N manufactured by Sharp Corporation (printing speed: <color> ppm, <monochrome> 62 ppm). In the multifunction printer MX-6200N, as shown in FIG. 2, the developer 1 is stirred and charged by the stirring screw 12 in a developing unit containing the developer 1. Further, the developer 1 is carried to the developer bearing member 13 provided therein with a magnet roller as a magnetic field generating means. Then, the developer 1 is held on a surface of the developer bearing member 13 by magnetic binding force. A two component developer 11 held on the surface of the developer bearing member 13 is controlled to a predetermined layer thickness by the developer controlling member 14, whereby a magnetic brush is formed in a section where the developer bearing member 13 and the image bearing member 15 face each other. Then, a bias voltage obtained by superimposing a direct-current bias voltage on an alternating-current voltage is applied to the developer bearing member 13. This allows only the toner to be adhered to an electrostatic latent image formed on a surface of the image bearing member 15 by a charging means and an exposing means (which are not illustrated), whereby a visible image is formed. In the multifunction printer MX-6200N, the surface of the image bearing member 15 is negatively charged by the charging means, and only an area to which the toner is adhered is exposed by the exposing means.

In the aging test, a direct-current bias value of the bias voltage to be applied to the developer bearing member 13 was (i) appropriately changed in accordance with a charge amount of the toner in each of the developers, and (ii) adjusted so that an image density of a solid image becomes a predetermined value. Moreover, an electrical potential of a nonimage area on the image bearing member 15 was set to be different by 200 V from an electrical potential of the developer bearing member 13.

Moreover, a toner consumption in the visible image formation was detected by a toner concentration sensor 16 as a change in the toner concentration which is a ratio of the toner by weight with respect to a weight of the developer. A toner was supplied from a toner hopper 17 by the amount of the toner consumed, until the toner concentration sensor 16 detected that a predetermined toner concentration was reached. This kept the toner concentration constant in the two component developer 11 contained in the developing unit 10. Moreover, in the multifunction printer MX-6200N, a gap between the developer bearing member 13 and the developer controlling member 14, and a gap between the developer bearing member 13 and the image bearing member 15 in a developing area were set to 0.4 [mm] in the present test. Note however that the gaps are not limited to the value.

(Comparison Between Carriers)

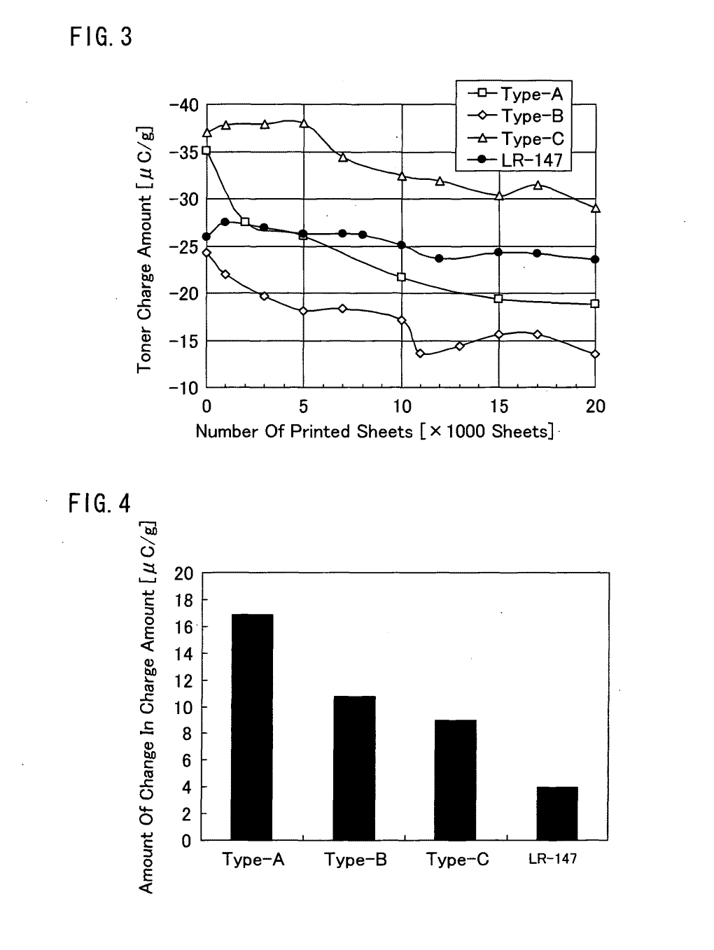

FIG. 3 illustrates transitions of toner charge amounts with use of the respective carriers in accordance with the number of printed sheets in the aging test at a coverage rate of 5% under the condition described above. As shown in FIG. 3, in cases where the three types of the carriers Type-A, Type-B, and Type-C, other than LR-147, were used, the respective toner charge amounts were steadily decreased as the number of printed sheets was increased. On the other hand, in a case where LR-147 was used, the toner charge amount was hardly decreased and kept stable for long periods. FIG. 4 illustrates each difference between a maximum value and a minimum value of the toner charge amounts (amount [μC/g] of change in charge amount) up to printing of 20,000 sheets, in each of the transitions of the toner charge amounts of the respective toners using the carriers shown in FIG. 3. As shown in FIG. 4, in the case of Type-A to which the charge control agent having the positive charging property whose polarity is a reverse polarity to the polarity of the charging property of the toner, the change in the charge amount is quite noticeable. However, in the cases of Type-B and Type-C provided with the charge control agents each having the negative charging property whose polarity is identical to the polarity of the charging property of the toner, the change in the charge amount is decreased, as compared with Type-A. That is, it is possible to reduce the change in the charge amount in accordance with the increase of the number of printed sheets by adding the charge control agent having the negative charging property whose polarity is identical to the polarity of the charging property of the toner. Further, in a case where LR-147 which is identical to the charge control agent added to the toner is used, it is proved that the change in the charge amount can be further reduced, as compared with the cases of Type-B and Type-C, and that the toner charge amount is stabilized.

From these results, it is inferred that the charging property of the toner with respect to the increase of the number of printed sheets can be stabilized by adding, to the carrier, the charge control agent having the negative charging property whose polarity is identical to the polarity of the charging property of the toner. Furthermore, the change in the charge amount can be further reduced by using the carrier provided with the charge control agent having the composition identical to that of the charge control agent added to the toner. Accordingly, high-quality images can be outputted stably for long periods.

Based on the above results, image qualities of outputted images were compared as to cases where 0 sheet has been printed and where 20,000 sheets have been printed with use of the four types of the carriers and the digital multifunction printer used in the aging test. As a result, regarding Type-A, it was confirmed that an image contrast of an image in a case where 20,000 sheets have been printed was apparently increased, as compared with an image in a case where 0 sheet has been printed, that is, the difference in image quality was noticeable. Regarding Type-B and Type-C, each difference of image contrasts between images of the cases where 0 sheet has been printed and where 20,000 sheets have been printed were reduced, as compared with Type-A. However, the difference of the image contrasts was visible to the eyes. On the other hand, in a case where LR-147 was used, the image quality including the image contrasts was substantially the same between images of the cases where 0 sheet has been printed and where 20,000 sheets have been printed. In this case, it was confirmed that even when the number of printed sheets were increased, the image quality was highly stable.

(Comparison Between Cases where Electrically Conductive Particles are Present and Absent)

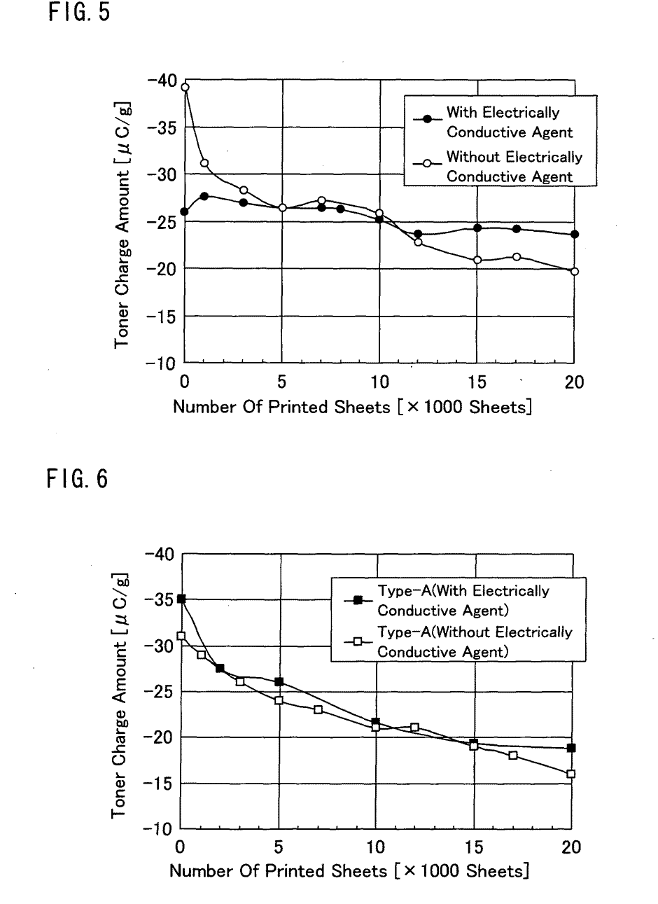

In the aging test carried out in the same manner as described above on two types of two component developers containing carriers, transitions of the toner charge amounts in accordance with a number of printed sheets were measured. The carrier in one of the two types of developers had the same structure as that of LR-147 and included electrically conductive particles (electrically conductive agent) in a coating layer of the carrier; whereas the other carrier in the other one of the two types of developers had the same structure as that of LR-147 but did not include the electrically conductive particles (electrically conductive agent). FIG. 5 illustrates results of the measurement. As shown in FIG. 5, in a case where the electrically conductive particles (electrically conductive agent) were not included, an apparent decrease in the charge amount was observed, as compared with a case where the electrically conductive particles (electrically conductive agent) were contained. Further, transitions of the toner charge amounts in accordance with a number of printed sheets were measured in the aging test carried out in the same manner as described above on other two types of two component developers containing carriers. One of the carriers in one of the two types of developers had an structure identical to that of Type A and included electrically conductive particles (electrically conductive agent) in a coating layer of the carrier; whereas the other carrier in the other one of the two types of developers had the structure identical to that of Type A but did not include the electrically conductive particles (electrically conductive agent). FIG. 6 illustrates results of the measurement. It is apparent from a comparison of FIG. 5 and FIG. 6 that the carrier using the charge control agent different from that of the toner cannot obtain an advantageous effect from addition of electrically conductive particles, unlike the carrier using the charge control agent identical to that of the toner.

From these results, in regard to the two component developer including the charge control agent identical to the charge control agent of the toner, it is clear that: the toner charge amount can be stabilized only when the electrically conductive particles are contained in the coating layer (carrier coating layer) of the carrier; however, the charge amount is decreased in a case where the electrically conductive particles are not contained.

As described above, it is important to stabilize the toner charge amount for maintaining a stable image quality for long periods. In order to stabilize the toner charge amount, it is highly effective to add, to the coating layer of the carrier, a combination of (i) electrically conductive particles and (ii) a charge control agent identical to a charge control agent added to the toner.

(Evaluation of Amount of Charge Control Agent Added)

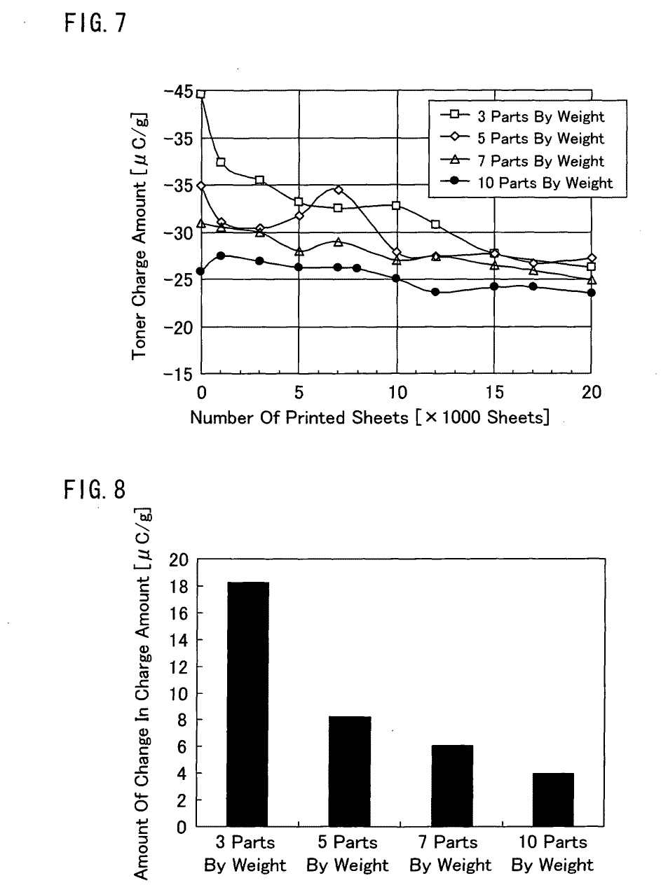

Amounts of the charge control agents added to the respective coating resin layers of the carriers were considered. FIG. 7 is a graph illustrating transition of toner charge amounts in a continuous printing process in each of respective cases where the amounts of the charge control agents added to the resin layer are 3 parts by weight, 5 parts by weight, 7 parts by weight, and 10 parts by weight, with respect to 100 parts by weight of the resin. Note that the charge control agent used in the test was LR-147. It was proved that the charge amount was stabilized as the amount of the charge control agent added was increased from 3 parts by weight to 5 parts by weight. Furthermore, the charge amount was further stabilized as the amount of the charge control agent added was increased to 7 parts by weight and further to 10 parts by weight. FIG. 8 illustrates differences each of which is a difference between a maximum value and a minimum value of the toner charge amounts (amount [μC/g] of change in charge amount) up to printing of 20,000 sheets, regarding the transitions of the toner charge amounts of the respective toners using the carriers each shown in FIG. 7.

Further, as described below, the charge control agent was evaluated as to the amount of change in the charge amount and adhesion of the carrier, in relation to the evaluation of the amount of the charge control agent added. The adhesion of the carrier was evaluated by measuring a number of adhered carrier in a predetermined area (297 mm×24 mm) in a nonimage area on the image bearing member.

The following Table 1 shows results of the measurement. In Table 1, “Good” represents that a result of the evaluation was good; “Fair” represents that the result was not too bad, and “Poor” represents that the result was bad.

TABLE 1

| | | Added amount of charge control agent | | | |
|---|---|---|---|---|---|
| | | 3 parts | 5 parts | 7 parts by | 10 parts |
| | | by weight | by weight | weight | by weight |
| Change in | Amount of | 18 | 8 | 6 | 4 |
| charge | Change | | | | |
| amount | [μC/g] | | | | |
| | Evaluation | Poor | Good | Good | Good |
| Adhesion of | Number of | 4 | 11 | 18 | 105 |
| carrier | adhered | | | | |
| | carriers | | | | |
| | [piece] | | | | |
| | Evaluation | Good | Good | Good | Fair |

In Table 1, the change in the charge amount was evaluated as “Poor” in the case of the amount of 3 parts by weight because an evident difference in image contrasts before and after continuous printing was observed in a sensory evaluation. Moreover, the adhesion of the carrier was evaluated as “Fair” in the case of the amount of 10 parts by weight because a slight roughness of a background of image (non-developing area) was observed in the sensory evaluation.

From these results, the toner charge amount in the continuous printing process can be stabilized by adding the charge control agent by 5 parts to 10 parts by weight with respect to the resin contained in the coating layer of the carrier. More preferably, the amount should be 7 parts to 10 parts by weight for achieving further stabilization.

(Evaluation of External Additives)

Regarding external additives each used as a material for improving fluidity of a toner, evaluation was made as to a difference in characteristic produced by combinations of two types of external additives having particle sizes different from each other. The external additives each may be an external additive generally used in this field. Examples of the external additives may be silicon oxide, titanium oxide, silicon carbide, aluminum oxide, and barium titanate. An amount of the external additives to be used is not limited. However, it is preferable that the amount is 0.1 part to 3.0 parts by weight with respect to 100 parts by weight of the toner particle. The two types of the external additives used for study were (i) silica hydrophobized with i-butyltrimethoxysilane having a volume average particle size of 100 nm and (ii) silica fine particles hydrophobized with HMDS having a volume average particle size of 12 nm. With respect to 97.8% by weight of toner base particles, 1.2% by weight of the silica and 1.0% by weight of the silica fine particles were added. The characteristics of the silica and the silica fine particles were evaluated as to two parameters, i.e., a toner charge amount and transfer property of the toner. Regarding the toner charge amount, in a case where a difference between an initial charge amount and a charge amount after printing of 20,000 sheets was within 10, it was evaluated as “Good”, and in a case where the difference was 10 or less, it was evaluated as “Poor”. Regarding the transfer property, in a case where the transfer efficiency was 90% or more, it was evaluated as “Good”, and in a case where the transfer efficiency was less than 90%, it was evaluated as “Poor”. Table 2 below shows the results.

TABLE 2

| | | Charge amount | | | | | |
|---|---|---|---|---|---|---|---|
| | | [-μC/g] | | | | | |
| | | | After | | | | |
| | | | printing | | Transfer property | | |
| | | | of | | Transfer | | |
| | | | 20000 | | efficiency | | Comprehensive |
| | Silica | Initial | sheets | Evaluation | [%] | Evaluation | evaluation |
| Example 1 | A | 26 | 14 | Poor | 94 | Good | Poor |
| Example 2 | B | 28 | 26 | Good | 82 | Poor | Poor |
| Example 3 | A, B | 27 | 23 | Good | 91 | Good | Good |

In Table 2, silica A is the silica having the volume average particle size of 100 nm, and silica B is the silica having the volume average particle size of 12 nm. As shown in Table 2, in a case where only the silica A was used, the transfer efficiency was high but the difference was large between the initial charge amount and the charge amount after the continuous printing. In a case where only the silica B was used, the charge amount was stable but the transfer efficiency was decreased. On the other hand, in a case where the silica A and the silica B were used together, it was proved that both the charging property and the transfer property were stable. From these results, it is preferable that at least two types of particles having particle sizes different form each other are adhered to the toner and that one type of these two types of particles has a particle size of 100 nm or more.

(Toner Charge Amount)

Image density and toner scattering at each of toner charge amounts were evaluated in view of the toner charge amount. Table 3 shows results of the evaluation. The charge amounts listed in Table 3 are values at points of 0 k, 5 k, 10 k, 15 k, 20 k in continuous printing with use of the four types of the charge control agents in FIG. 4. In the evaluation, a solid image density was measured as the image density by a spectrodensitometer X-Rite 939. The solid image was an image obtained in a case where a direct-current bias value of the bias voltage to be applied to the developer bearing member was −600 V. In a case where the measured value was 1.4 or more, the image density was judged as good. Note that, even in a case where the image density was considerably larger than 1.4, the image density was still judged as good because a proper density can be obtained by adjusting the direct-current bias value. Regarding the toner scattering, toner adhesion was evaluated by visual observation of a housing in an upper section of the developing unit, after idling for two minutes without forming an image at each point of the measurement.

TABLE 3

| Charge | | | | | | | |
|---|---|---|---|---|---|---|---|
| control | | | | | | | |
| agent | Characteristics | | 0k | 5k | 10k | 15k | 20k |
| Type-A | Charge amount | | 35 | 26 | 22 | 19 | 19 |
| | [-μC/g] | | | | | | |
| | Image | Value | 1.4 | 1.7 | 1.8 | 1.9 | 1.9 |
| | density | Evaluation | Good | Good | Good | Good | Good |
| | Toner scattering | | Good | Good | Good | Good | Good |
| Type-B | Charge amount | | 24 | 18 | 17 | 15 | 13 |
| | [-μC/g] | | | | | | |
| | Image | Value | 1.7 | 1.9 | 1.9 | 2.0 | 2.0 |
| | density | Evaluation | Good | Good | Good | Good | Good |
| | Toner scattering | | Good | Good | Fair | Fair | Poor |
| Type-C | Charge amount | | 37 | 38 | 32 | 30 | 29 |
| | [-μC/g] | | | | | | |
| | Image | Value | 1.3 | 1.3 | 1.4 | 1.5 | 1.5 |
| | density | Evaluation | Poor | Poor | Good | Good | Good |
| | Toner scattering | | Good | Good | Good | Good | Good |
| LR-147 | Charge amount | | 26 | 26 | 25 | 24 | 23 |
| | [-μC/g] | | | | | | |
| | Image | Value | 1.7 | 1.7 | 1.7 | 1.7 | 1.8 |
| | density | Evaluation | Good | Good | Good | Good | Good |

| | | | | | |
|---|---|---|---|---|---|
| Toner scattering | Good | Good | Good | Good | Good |

As shown in Table 3, regarding the image density, it was proved that when an absolute value of the toner charge amount was more than 35 μC/g, the image density becomes lower than the target value 1.4. Besides, it was proved that when the absolute value of the toner charge amount was 35 μC/g or less, a sufficient image density was obtained. Moreover, regarding the toner scattering, it was proved that when the absolute value of the toner charge amount was less than 15 μC/g, the scattering became apparent, and when the absolute value of the toner charge amount was 15 μC/g or more, the scattering was reduced.

As shown in the results, in order to attain the target image density, the absolute value of the toner charge amount needs to be 35 μC/g or less, and in order to prevent the toner scattering from being occurred, the absolute value of the toner charge amount needs to be 15 μC/g or more. Accordingly, in order to attain both the target image density and the prevention of the toner scattering, it is effective to set the absolute value of the toner charge amount to 15 μC/g or more but 35 μC/g or less. In a case where the absolute value of the toner charge amount is 15 μC/g or more but 35 μC/g or less, the toner scattering and photographic fog due to lower charging can be prevented. Further in such a case, an insufficient density of a solid image due to higher charging can be also prevented. This makes it possible to maintain an excellent image quality.

(Sizes of Carrier and Toner)

Image qualities of outputted images were evaluated regarding two component developers each of which includes (i) a toner produced as above having a volume average particle size of 6.7 μm and (ii) one of carriers produced as above having average particle sizes of 35 μm, 45 μm, 55 μm, and 95 μm. Table 4 below shows the results.

TABLE 4

| | 35 μm | 45 μm | 55 μm | 95 μm |
|---|---|---|---|---|
| Granularity | Good | Good | Fair | Poor |
| Thin line | Good | Good | Fair | Poor |
| uniformity | | | | |

As shown in Table 4, it is preferable that the average particle size of the carrier is set to 45 μm or less for attaining both the granularity and the thin line uniformity of a halftone area. This result applies to a case where respective toners having particle sizes of 5 μm and 7 μm are used. Accordingly, in a case where a toner having an average particle size of 5 μm to 7 μm is used, it is preferable that the average particle size of the carrier is 45 μm or less.

Note that the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

As described above, a developer of the present invention includes: a toner; and a carrier, wherein: the toner contains a charge control agent; the carrier has, on a surface of the carrier, a coating layer to which a charge control agent and electrically conductive particles are added; and all of constituent elements of one of the charge control agent contained in the toner and the charge control agent of the carrier are contained in constituent elements of the other one of the charge control agents.

Moreover, a developer of the present invention may include: a toner; and a carrier, wherein: the carrier has on its surface a coating layer to which a charge control agent and electrically conductive particles are added; and the charge control agent has a composition identical to a composition of the charge control agent contained in the toner.

According to the configuration, a combination of (i) the charge control agent having the composition identical to the composition of the charge control agent contained in the toner and (ii) the electrically conductive particles is added to the coating layer of the carrier, whereby a stable amount of charge can be provided to the toner even in a case where the number of sheets printed is increased. The charge control agent and the electrically conductive particles which are present on a newly exposed surface of the coating layer serve effectively, even in a case where the coating layer is chipped or peeled due to mechanical stress applied on the carrier during a long-term use. This makes it possible to prevent a decrease in the toner charge amount in accordance with deterioration of the carrier due to an increase in the number of sheets printed.

Accordingly, a developer having any of the configurations above makes it possible to reproduce highly fine images for long periods, and form high quality images each having excellent color reproducibility, a high image density, and little image defection such as photographic fog. Moreover, the developer makes it possible to prevent toner scattering caused by a decrease in toner charge amount, thereby preventing contamination inside an apparatus. Further, images can be formed stably.

Moreover, in addition to the configuration, the coating layer in the developer of the present invention may be made of a resin composition, and the charge control agent may be added by 5 parts to 10 parts by weight with respect to 100 parts by weight of a resin contained in the resin composition. The configuration makes it possible to stabilize the charging property and form images stably for long periods, by properly adjusting the amount of the charge control agent to be added. Further, in a case where the charge control agent is added by 5 parts to 7 parts by weight with respect to 100 parts by weight of a resin contained in the resin composition, the charging property can be further stabilized and images can be formed stably for longer periods.

Moreover, in the developer of the present invention, in addition to the configurations, at least two or more types of particles having particle sizes different form each other may be externally added to the toner.

According to the configuration, at least two or more types of particles having particle sizes different form each other are externally added to the toner. This can improve a transfer efficiency in a transfer process while preventing a decrease in the toner charge amount in accordance with an increase in the number of sheets printed. This makes it possible to realize stable image formation for long periods. For example, even in a case where at least one of the particles externally added to the toner is so large as to have a primary particle size of 0.1 μm or more, in particular, even in a case where a color toner is used, the transfer property is improved and the toner can be charged stably for long periods without causing deterioration in charging due to adhesion of the external additive to the surface of the carrier.

Moreover, in the developer of the present invention, in addition to the configurations, the charge control agent may not contain a heavy metal.

According to the configuration, a charge control agent which does not contain a heavy metal is contained in the coating layer of the carrier. This makes it possible to produce a carrier and eventually a developer, taking environmental pollution and human suffering into account. Moreover, in a case where the coating layer is made of a resin composition, a mechanical strength of the resin is not decreased even when a charge control agent is contained in the resin.

Moreover, in addition to the configurations, in the developer of the present invention, the toner may have an average particle size of 5 μm to 7 μm, and the carrier may have an average particle size of 45 μm or less. It is possible to output an image while attaining both granularity and thin line uniformity of a halftone area, by using the developer containing the toner having an average particle size of 5 μm to 7 μm and the carrier having an average particle size of 45 μm or less. In the developer of the present invention, even in the case of the toner having such a particle size, a toner charge amount can be stably maintained.

A developing unit of the present invention contains any of the developers therein. The developing unit is capable of developing an image while stabilizing the toner charge amount, and capable of providing advantageous effects the same as described above.

Further, in addition to the configuration, the developing unit of the present invention may include: an stirring mechanism for mixing the developer provided in the developing unit; a developer bearing member for holding the developer; and a developer controlling member for controlling an amount of the developer to be supplied to an image bearing member, the developer being held on the developer bearing member.

A developing device of the present invention develops an image with use of any of the developing units. The developing device is capable of developing an image while stabilizing the toner charge amount, and capable of providing advantageous effects the same as described above.

An image forming apparatus of the present invention includes: the developing device; and a transfer means including an intermediate transfer member on which a plurality of toner images having different colors are formed.

According to the configuration, the developer of the present invention having the configuration as described above is used, whereby the toner charge amount can be stabilized. Accordingly, with use of the mechanism (i) which is provided with the intermediate transfer member and (ii) in which toner images are transferred twice, the advantageous effects of the carrier and the developer as described above can be provided more effectively.

### INDUSTRIAL APPLICABILITY

The developer, the developing device, and the image forming apparatus of the present invention are suitable for use in an electrophotographic copying machine, a printer, a facsimile, and the like.

1. A developer comprising:
a toner; and
a carrier, wherein:
the toner contains a charge control agent;
the carrier has, on a surface of the carrier, a coating layer to which a charge control agent and electrically conductive particles are added; and
all of constituent elements of one of the charge control agent contained in the toner and the charge control agent of the carrier are contained in constituent elements of the other one of the charge control agents.

2. The developer as set forth in claim 1, wherein:
the charge control agent of the carrier includes elements identical to constituent elements of the charge control agent contained in the toner.

3. The developer as set forth in claim 2, wherein:
the charge control agent of the carrier has a composition identical to a composition of the charge control agent contained in the toner.

4. The developer as set forth in claim 1, wherein:
the coating layer contains a silane coupling agent.

5. The developer as set forth in claim 4, wherein:
the silane coupling agent contains an amino group.

6. The developer as set forth in claim 1, wherein:
the coating layer is made of a resin composition; and
the charge control agent is added by 5 parts to 10 parts by weight with respect to 100 parts by weight of a resin contained in the resin composition.

7. The developer as set forth in claim 1, wherein:
the coating layer is made of a resin composition; and
the charge control agent is added by 5 parts to 7 parts by weight with respect to 100 parts by weight of a resin contained in the resin composition.

8. The developer as set forth in claim 7, wherein:
the resin composition contains at least one of a silicone resin and a denatured resin of the silicone resin.

9. The developer as set forth in claim 1, wherein:
at least two or more types of particles having particle sizes different from each other are externally added to the toner.

10. The developer as set forth in claim 9, wherein:
at least one type of the particles externally added to the toner has a primary particle size of 0.1 μm or more.

11. The developer as set forth in claim 1, wherein:
the charge control agent does not contain a heavy metal.

12. The developer as set forth in claim 1, wherein:
the toner has an average particle size of 5 μm to 7 μm; and
the carrier has an average particle size of 45 μm or less.

13. A developing unit in which a developer as set forth in claim 1 is provided.

14. The developing unit as set forth in claim 13, further comprising:
a stirring mechanism for mixing the developer provided in the developing unit;
a developer bearing member for holding the developer; and
a developer controlling member for controlling an amount of the developer to be supplied to an image bearing member, the developer being held on the developer bearing member.

15. A developing device for developing an image with use of a developing unit as set forth in claim 13.

16. An image forming apparatus comprising:
a developing device as set forth in claim 15; and
a transfer means including an intermediate transfer member on which a plurality of toner images having different colors are formed.
